(19) United States
(12) Patent Application Publication
(10) Pub. No.: US 2007/0272251 A1
(43) Pub. Date: Nov. 29, 2007

(54) Retainer for intubation tubes

(76) Inventor: John Hodge, Brooklyn, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/439,079

(22) Filed: May 23, 2006

(51) Int. Cl. A62B 9/06

(52) U.S. Cl. 128/207.17; 128/207.14

(57) ABSTRACT

The retainer for one or more intubation tubes includes a bracket having a first part divided into first and second sections each adapted to engage a tube and retain same in alignment with a nostril, and a second part connected to the first part, and adapted to engage another tube and retain same in alignment with the mouth. Straps are provided for encircling the head and engaging the bracket to secure the retained to the head of the patient. The first and second sections of the first part are elastically connected to permit the distance therebetween to be adjusted. Flexible teeth on the inside surfaces of the parts are provided for engaging the tubes on the bracket in a unidirectional position adjustable manner so as to permit insertion but not withdrawal of the tube relative to the bracket.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to intubation tubes and more particularly to a device for retaining one or more intubation tubes, after same that have been inserted into a patient, without adhesive attachment to the skin of the patient.

2. Description of Prior Art Including Information Disclosed Under 37 CFR 1.97 and 1.98

Intubation refers to the act of insertion of a tube, through the nose or mouth, into a body cavity, such as the lungs or stomach of a patient, for the purpose of the introduction of a gas, such as oxygen, a liquid, such as a supplement for feeding, into the body, or the application of a suction for the removal or evacuation of a gas or liquid from the body.

It is important that the intubation procedure be performed with extreme care to avoid injury to the patient and at the same time insure that the distal end of the inserted tube is situated at the proper location within the body. It is equally important that the intubation tube be secured in position after insertion to eliminate the possibility of the distal end being accidentally dislodged from the desired location.

One common way to secure an intubation tube is to fix an external portion of the tube to the skin of the patient proximate the nose or mouth by adhesive tape. However, adhesive tape can be irritating to the skin, painful to remove and ineffective if it becomes wet.

In order to overcome those disadvantages, various types of tube immobilizers and retainers have been developed. Those devices often include an elastic strap adapted to encircle the head of the patient. Some include a bracket which is designed to extend into the mouth a short distance. The exterior portion of the tube is attached to the strap, or to the bracket connected to the strap, by friction or by a fastening device such as a clamp, screw, tie, adhesive, hook and loop fastening strip or the like.

However, conventional devices of that type have a number of disadvantages. They normally are designed to retain only one particular type of tube, such as an endrotracheal tube and cannot be used with other types of tubes. Further, they are normally incapable of accommodating more than one tube at a time.

The methods used to retain the tube are often insufficiently secure, as in the case when friction is used. Other methods are mechanically awkward, such as when clamps, screws or ties are used. Commonly, they do not permit easy insertion and adjustment of the tube, such as is the case with adhesive and hook and loop fastening strips.

It is therefore a prime object of the present invention to provide an intubation tube retainer capable of securely retaining one or more tubes without causing irritation to the skin of the patient.

It is another object of the present invention to provide an intubation tube retainer that can accommodate one or more tubes of various types.

It is another object of the present invention to provide an intubation tube retainer that can accommodate tubes of various sizes.

It is another object of the present invention to provide an intubation tube retainer that permits the insertion of the tube but not the withdrawal thereof, such that the distal end of the tube cannot be accidentally dislodged once properly located.

It is another object of the present invention to provide an intubation tube retainer that does not rely on adhesive, glue or tape to secure the tube.

It is another object of the present invention to provide an intubation tube retainer that does not include difficult to apply mechanical devices such as clamps, screws, ties, hook and loop fastening strips or the like to secure the tube.

It is another object of the present invention to provide an intubation tube retainer that is comfortable to wear and easy to remove.

It is another object of the present invention to provide an intubation tube retainer that is inexpensive enough to be disposable and yet sturdy enough to be used over a significant time period.

The above objects are achieved by my invention.

### BRIEF SUMMARY OF THE INVENTION

In accordance with one aspect of the present invention a retainer is provided for intubation tubes. The retainer includes a bracket. The bracket has a first part that has first and second sections each adapted to engage a tube and retain same in alignment with a nostril, a second part connected to the first part and adapted to engage another tube and retain same in alignment with the mouth. Means are provided for encircling the head and engaging the bracket. Means are provided for adjustably connecting the first and second sections of the first part to alter the distance therebetween. Means are also provided for engaging a tube to the bracket in a unidirectional position adjustable manner so as to permit insertion but not withdrawal of the tube relative to the bracket.

Preferably, the means for adjustably connecting the first and second sections takes the form of elastic means extending between the first and second sections.

The retainer may also include means for detachably connecting the first and second parts, as well as means for detachably connecting the second part to the head encircling means.

The tube engaging means includes a surface on the bracket and a plurality of arcuate teeth extending from the surface. The teeth each have a tip either extending in the general direction of tube insertion or inclined in the general direction of tube insertion. Preferably the tip extends in a direction between a line perpendicular to the surface and a line parallel to the surface. The teeth are preferably formed of flexible material.

The bracket is preferably formed of soft plastic. Preferably, the detachable connecting means includes hook and loop fasteners.

The head encircling means may be formed of cloth or elastic. It may include first and second strips of material and a cloth pad. The first and second strips respectively extend between each of the bracket sections and the pad.

One bracket section includes a tube receiving opening. The surface from witch the teeth extend at least in part defines the tube receiving opening.

### BRIEF DESCRIPTION OF THE SEVERAL VIEWS OF DRAWINGS

To those and to such other objects which may hereinafter appear, the present invention relates to a retainer for intubation tubes as described in the following specification and recited in the annexed claims, taken together with the accompanying drawings, in which like numerals refer to like parts and wherein:

FIG. 1 is an environmental view showing a patient with an intubation tube inserted in the mouth that is retained by the retainer of the present invention;

FIG. 2 is a view similar to FIG. 1 but showing an intubation tube retained in the nostril.

FIG. 3 is an isometric partially exploded view of the retainer of the present invention.

FIG. 4 is an enlarged isometric view of the connection between one of the nostril tube retaining sections and the mouth tube retaining part.

FIG. 5 is a view similar to FIG. 4, showing the nostril tube retaining section exploded from the mouth tube retaining part.

FIG. 6 is a cross-sectional view of the one of the nostril tube retaining sections with a tube extending therethrough, showing the teeth; and

FIG. 7 is an exploded view of the bracket, a tube and an adapter for the tube.

### DETAILED DESCRIPTION OF THE INVENTION

As seen in FIGS. 1, 2 and 3, the retainer of my invention includes a bracket 10 which has a top part 12 formed of two nostril tube retaining sections 12a, 12b each generally in the form of a soft plastic ring. Sections 12a and 12b are connected to each other by an elastic band 14 such that the distance between the nostril tube retaining sections 12a and 12b can be easily altered.

Each of the nostril tube retaining sections 12a, 12b of top part 12 is detachably connected to a mouth tube retaining part 16 by a connector 18. Connector 18 is formed of flexible material such that the nostril tube retaining section 12a or 12b attached thereto can pivot relative to the plane of part 16, as illustrated in FIGS. 1 and 4. Part 16 is also made of soft plastic and takes the form of a ring. However, the opening in part 16 is larger than those in the nostril tube retaining sections 12 because of the size of the tube to be retained thereby.

A pad 20 made of soft material such as cloth is provided. Pad 20 is adapted to be situated behind the head of the patient and is connected to bracket 10 by cloth or elastic straps 22a, 22b and 24a, 24b.

Each corner of the exterior surface of pad 20 is provided with a section of hook and loop fastening tape 26. The back end of each of four straps 22a, 22b, 24a and 224b is provided with a mating hook and loop tape section 28 provided to engage a different one of the sections 26 on pad 20.

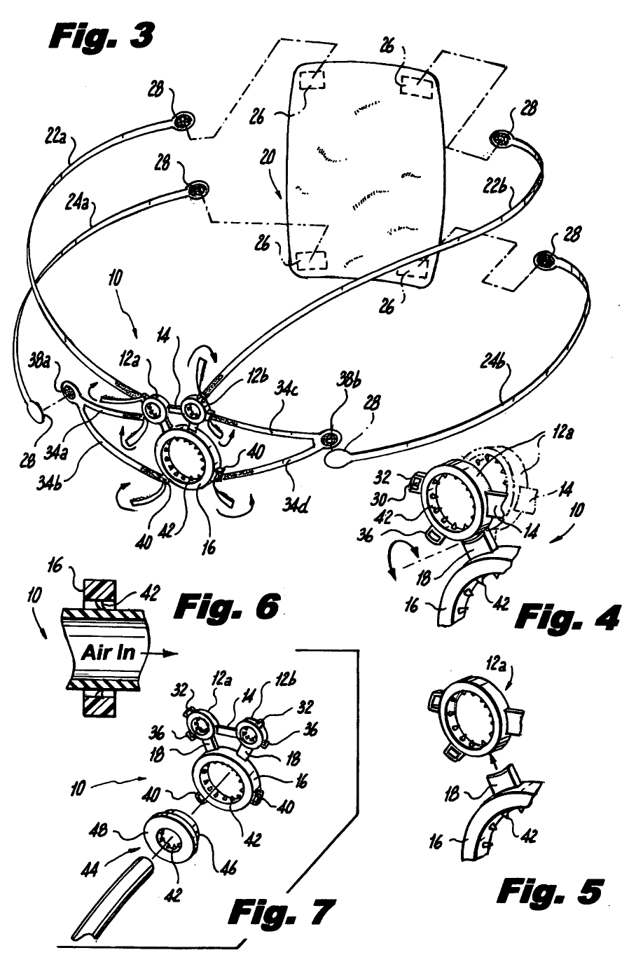

The front ends of straps 22a and 22b extend through openings 30 in buckles 32 extending from the upper portions of sections 12a, 12b. As illustrated in FIG. 3, the interior surface of the end of each strap 22a, 22b is provided with a section of hook and loop fastener tape such that the strap end can be opened and the strap tightened as needed.

The front ends of straps 24a, 24b are also provided with tape sections 28. Two sets of shorter straps 34a, 34b and 34c, 34d, respectively, extend outwardly in opposite directions from bracket 10. As illustrated in FIG. 3, the forward end of the top strap 34a, 34c in each set is provided with a section of hook and loop fastener tape on the interior surface and is adapted to engage the lower buckle 36 on each section 12 in a detachable and adjustable manner. The other end of strap 34a, 34c is connected to a generally round end part 38a, 38b respectively.

The forward end of each lower strap 34b, 34d is also provided with hook and loop fastener tape on its interior surface such that it can detachably and adjustably engage one of the buckles 40 on either side of part 16. The other end of each strap 34b, 34d terminates at end part 38a, 38b respectively.

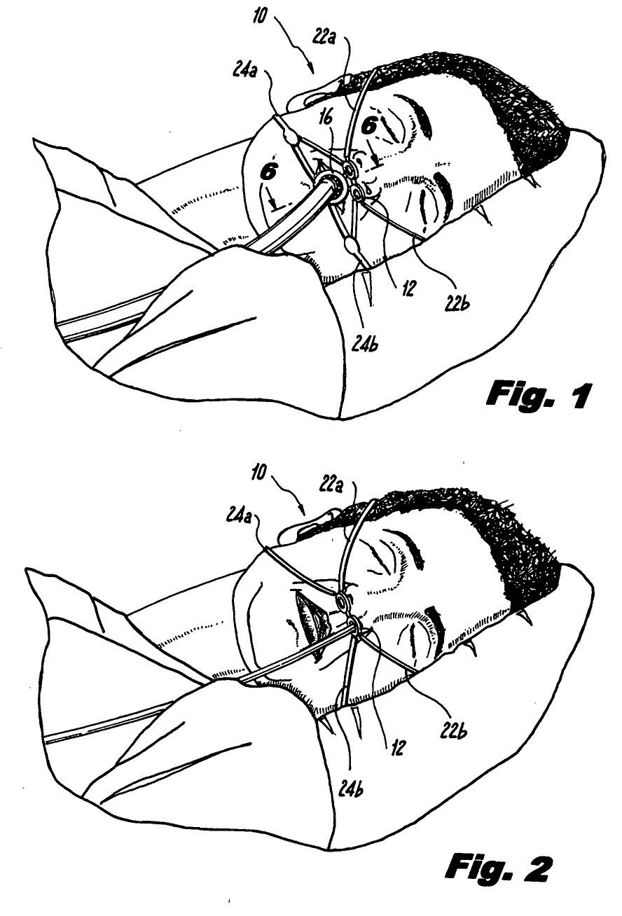

Each of the end parts 38a, 38b is provided with mating hook and loop fastening tape so as to detachably connect with the ends of straps 24a and 24b, respectively. This permits bracket 10 to be used to retain a mouth tube, as illustrated in FIG. 1, or part 16 to be removed, such that only a nose tube is retained, as shown in FIG. 2.

A plurality of flexible teeth 42 are provided in the interior surface of each of the nostril tube retaining sections 12a, 12b and on the interior surface of the mouth tube retaining part 16. Teeth 42 either have an arcuate body so that the tip extends in the general direction of tube insertion or the body is inclined relative to the surface from which it extends such that the tip points in the general direction of tube insertion. Preferably, in either case, the tip extends in a direction between a line perpendicular to the surface and a line parallel to the surface. Teeth 42 are formed for flexible material.

The purpose of teeth 42 is to provide a uni-directional clamping mechanism between the tube and the bracket which permits a tube to be moved relative to the bracket in the direction of tube insertion but prevents movement of the tube relative to the bracket in the opposite direction. Accordingly, the teeth permit insertion of the tube, but not withdrawal of the tube.

As seen in FIG. 7, a mouth tube having a diameter smaller that the diameter of the opening in part 16 may be used with the bracket if an adapter 44 is utilized. Adapter 44 is a soft plastic ring that has a smaller inner portion 46 sized to be received and retainer within the opening of part 16 and a larger outer portion 48 that prevents portion 46 from being pushed through part 16. Preferably, the interior surface of adapter 44 is also provided with teeth 42 such that a smaller mouth tube held by adapter 44 may be moved in the insertion direction but not withdrawn from the bracket.

It should now be appreciated that the present invention provides an intubation tube retainer capable of securely retaining one or more tubes without causing irritation to the skin of the patient. The intubation tube retainer can accommodate one or more tubes of various types and/or sizes. Further, the intubation tube retainer permits the insertion of the tube but not the withdrawal thereof, such that the distal end of the tube cannot be accidentally dislodged once properly located.

In addition, the intubation tube retainer does not rely on adhesive, glue or tape to secure the tube. Nor does it include difficult to apply mechanical devices such as clamps, screws, ties, hook and loop fastening strips or the like to secure the tube. It is comfortable to wear and easy to remove. It is also inexpensive enough to be disposable, yet sturdy enough to be used over a significant time period.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A retainer for intubation tubes comprising: a bracket, said bracket comprising a first part, said first part comprising first and second sections each adapted to engage and retain a tube in alignment with a nostril, a second part connected to said first part and adapted to engage and retain another tube in alignment with the mouth, means for encircling the head and engaging said bracket, means for adjustably connection said first and second sections of said first part to alter the distance therebetween and means for engaging a tube to said bracket in a unidirectional position adjustable manner so as to permit insertion but not withdrawal of the tube relative to said bracket.

2. The retainer of claim 1 wherein said means for adjustably connection said first and second sections comprises elastic means.

3. The retainer of claim 1 further comprising means for detachably connection said first and second parts.

4. The retainer of claim 1 further comprising means for detachably connecting said second part to said head encircling means.

5. The retainer of claim 1 further wherein said engaging means comprises a surface and a plurality of arcuate teeth extending from said surface.

6. The retainer of claim 5 wherein at least one of said teeth comprises a tip extending in the general direction of tube insertion.

7. The retainer of claim 1 wherein said engaging means comprises a surface and a plurality of teeth extending from said surface, said teeth being inclined in the general direction of tube insertion.

8. The retainer of claim 5 wherein at least one of said teeth comprises a tip extending in a direction between a line generally perpendicular to said surface and a line generally parallel to said surface.

9. The retainer of claim 7 wherein at least one of said teeth comprises a tip extending in a direction between a line generally perpendicular to said surface and a line generally parallel to said surface.

10. The retainer of claim 5 wherein said teeth comprise flexible material.

11. The retainer of claim 7 wherein said teeth comprise flexible material.

12. The retainer of claim 1 wherein said bracket comprises soft plastic.

13. The retainer of claim 3 wherein said detachable connecting means comprises hook and loop fasteners.

14. The retainer of claim 4 wherein said detachable connecting means comprises hook and loop fasteners.

15. The retainer of claim 1 wherein said encircling means comprises both.

16. The retainer of claim 1 wherein said encircling means comprises elastic.

17. The retainer of claim 1 wherein said encircling means comprises first and second strips of material.

18. The retainer of claim 1 wherein said encircling means comprises a pad and first and second strips respectively extending between said bracket and said pad.

19. The retainer of claim 5 wherein one of said sections comprises a tube receiving opening and wherein said surface at least in part defines said opening.

20. The retainer of claim 7 wherein one of said sections comprises a tube receiving opening and wherein said surface at least in part defines said opening.
